(19) United States
(12) Patent Application Publication
(10) Pub. No.: US 2026/0244315 A1
(43) Pub. Date: Aug. 20, 2026

(54) DISPLAY CONTROL DEVICE, DISPLAY CONTROL METHOD, AND DISPLAY CONTROL PROGRAM

(71) Applicant: NTT, Inc., Tokyo (JP)

(72) Inventors: Taisuke WAKASUGI, Tokyo (JP); Masashi TADOKORO, Tokyo (JP); Hideaki TANAKA, Tokyo (JP); Haruo OISHI, Tokyo (JP)

(73) Assignee: NTT, Inc., Tokyo (JP)

(21) Appl. No.: 18/872,123

(22) PCT Filed: Jun. 7, 2022
(86) PCT No.: PCT/JP2022/023025

§ 371 Date: Dec. 5, 2024

(51) Int. Cl. G06F 3/0484; G06F 3/0482

(52) U.S. Cl. CPC G06F 3/0484; G06F 3/0482

(57) ABSTRACT

A display control device stores extended UI rule information in which a condition of an operation order, an operation time, and the number of operations for permitting an input operation to an extended UI is set as a rule for controlling an input operation to the extended UI of a web system. For example, in a case where an input operation of personal information to an extended UI is detected, the display control device determines whether or not the input operation to the corresponding extended UI satisfies a condition for permitting an input operation to the corresponding extended UI set in the extended UI rule information. In a case of determining that the input operation to the corresponding extended UI does not satisfy a condition for permitting an input operation to the corresponding extended UI, the display control device restricts an input operation to an extended UI subsequent to the corresponding extended UI.

### TECHNICAL FIELD

The present invention relates to a display control device, a display control method, and a display control program for a screen of a web system.

### BACKGROUND ART

Conventionally, in order to support a user's operation on a screen of a web system, there is a technology of preparing a UI for extension (extended UI) which supports a user's operation in addition to a UI (existing UI) included in the screen of the web system and displaying the extended UI in an overlay manner on the existing UI on the screen. When the extended UI receives the user's operation, details of the operation are transmitted to the existing UI corresponding to the extended UI. Consequently, the web system can process the user's operation as an operation which is to be performed on the existing UI (see Patent Literature 1).

Here, a rule regarding an input operation is set for each extended UI so that the user can perform an appropriate input operation on the screen of the web system. For example, in a case where information that can be input to the existing UI of the screen of the web system is limited, an extended UI that displays the information that can be input in a pull-down menu is prepared as the extended UI corresponding to the existing UI. When the extended UI receives a user's selection input from the pull-down menu, the extended UI transmits the selected information to the existing UI. In this way, it is possible to support a user's operation on a screen of a web system without modifying the web system itself.

### CITATION LIST

### Patent Literature

Patent Literature 1: JP 2017-072872 A

### SUMMARY OF INVENTION

### Technical Problem

Here, input of personal information may also be received from an extended UI on a screen of a web system.

In this case, there is a risk that personal information can be input by spoofing since there is no personal authentication function regarding an input using the extended UI in the related art. Therefore, an object of the present invention is to solve the above-described problem and to prevent an input to an extended UI by spoofing.

### Solution to Problem

In order to solve the problem described above, the present invention includes: a storage unit that stores extended UI rule information in which a condition regarding at least one of an operation order, an operation time, and the number of operations of an extended UI for permitting an input operation to the extended UI is set as a rule for controlling an input operation to the extended UI of a web system; a determination unit that determines whether or not an input operation to a predetermined extended UI satisfies a condition for permitting an input operation to the corresponding extended UI set in the extended UI rule information in a case where the input operation to the corresponding extended UI is detected; and a control processing unit that restricts, in a case of determining that the input operation to the extended UI does not satisfy a condition for permitting an input operation to the corresponding extended UI, an input operation to an extended UI subsequent to the corresponding extended UI.

### Advantageous Effects of Invention

According to the present invention, it is possible to prevent input to an extended UI by spoofing.

### BRIEF DESCRIPTION OF DRAWINGS

FIG. 1 is a diagram for illustrating an operation outline of a display control device.

FIG. 2 is a diagram for illustrating the operation outline of the display control device in detail.

FIG. 3 is a diagram illustrating a configuration example of the display control device.

FIG. 4 is a flowchart illustrating an example of a processing procedure of the display control device.

FIG. 5 is a diagram illustrating an example of a computer that executes a display control program.

### DESCRIPTION OF EMBODIMENTS

Hereinafter, modes (embodiments) for carrying out the present invention will be described with reference to the drawings. The present invention is not limited to the embodiments to be described below.

### Extended UI

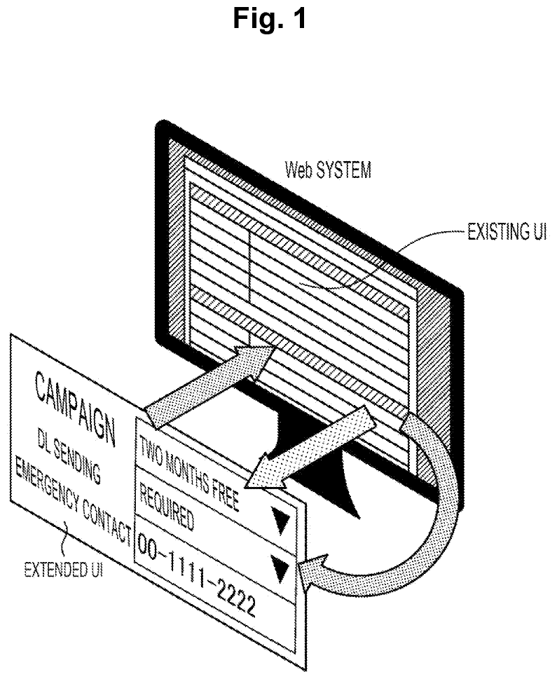

First, an extended user interface (UI) in the present embodiment will be briefly described. For example, as illustrated in FIG. 1, the extended UI is a UI overlaid and displayed on an existing UI (UI originally provided in a web system) constituting a screen of the web system in order to support a user's operation of the web system. For example, the extended UI displays input candidates or the like for the user on the basis of a rule set in the extended UI and receives a selection input (input operation) from the user. Then, details of the extended UI and the input operation thereof are transmitted to the existing UI corresponding to the extended UI. Then, the web system performs processing on the basis of the details of the operation transmitted to the existing UI.

Consequently, the web system processes the user's operation as an operation which is to be performed on the existing UI as being operated by the user. This extended UI is realized by, for example, the technology described in Patent Literature 1.

### Outline

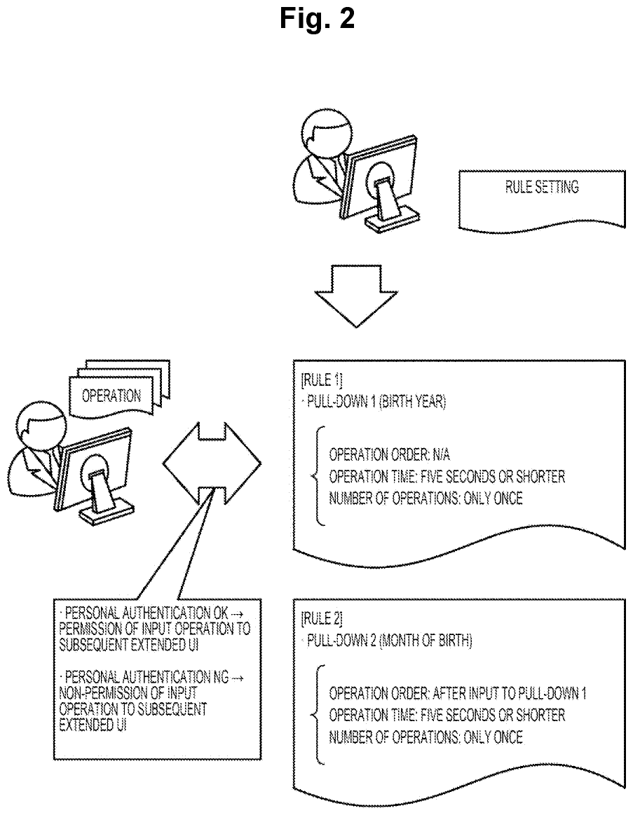

First, an operation outline of a display control device according to the present embodiment will be described with reference to FIG. 2. The display control device sets a condition for permitting an input to the extended UI as a rule of the extended UI that receives an input of personal information or the like in the web system.

For example, as illustrated in FIG. 2, the display control device receives setting of a condition such as an operation order, an operation time, or the number of operations of the extended UI as a condition for permitting an input operation to the extended UI.

As an example, as illustrated in FIG. 2, regarding the extended UI (pull-down 1) that receives an input of a birth year on a pull-down, setting of a condition (rule 1) that an input operation to the extended UI is permitted when the operation time to the extended UI is 5 seconds or shorter and the operation is performed once is received.

In addition, regarding the extended UI (pull-down 2) that receives an input of a month of birth on a pull-down, setting of a condition (rule 2) that an input operation to the extended UI is permitted when the operation order of the extended UI is after an input to the extended UI of the pull-down 1, the operation time is 5 seconds or shorter, and the operation is performed once is received.

After the above-described setting of the condition, when the display control device detects an operation to the extended UI of the pull-down 1, the display control device determines whether or not the operation to the extended UI satisfies the condition described in the above-described rule 1. Here, in a case where the display control device determines that the operation to the extended UI satisfies the above-described condition, the display control device determines that the personal authentication is OK and permits an input operation to an extended UI subsequent to the pull-down 1. On the other hand, in a case where the display control device determines that the operation to the extended UI does not satisfy the above-described condition, the display control device determines that the personal authentication is NG and does not permit an input operation to an extended UI subsequent to the pull-down 1.

Next, when the display control device detects an operation to the extended UI of the pull-down 2, the display control device determines whether or not the operation to the extended UI satisfies the condition described in the above-described rule 2. Here, in a case where the display control device determines that the operation satisfies the above-described condition, the display control device determines that the personal authentication is OK and permits an input operation to an extended UI subsequent to the pull-down 2. On the other hand, in a case where the display control device determines that the operation to the extended UI does not satisfy the above-described condition, the display control device determines that the personal authentication is NG and does not permit an input operation to an extended UI subsequent to the pull-down 2.

That is, in a case where the user himself/herself inputs personal information such as a date of birth and an address of the user, the user can input the personal information without hesitation, but in the case of spoofing, there is a possibility that the user may hesitate or make a mistake. For example, in a case where personal information is input to the extended UI by spoofing, there is a possibility that the operation order of the extended UI may be wrong, the operation time may be long, or the operation may be performed twice or more.

Therefore, the display control device uses the condition such as the operation order, the operation time, or the number of operations of the extended UI as the condition for permitting an input operation to the extended UI of the personal information. Consequently, the display control device can prevent an input operation from being performed to the extended UI of the personal information by spoofing.

In addition, the display control device may output an alert in a case where the input operation to the extended UI of the personal information of the user does not satisfy the above-described condition. Consequently, the display control device can detect an input operation of personal information by spoofing.

### Configuration of Display Control Device

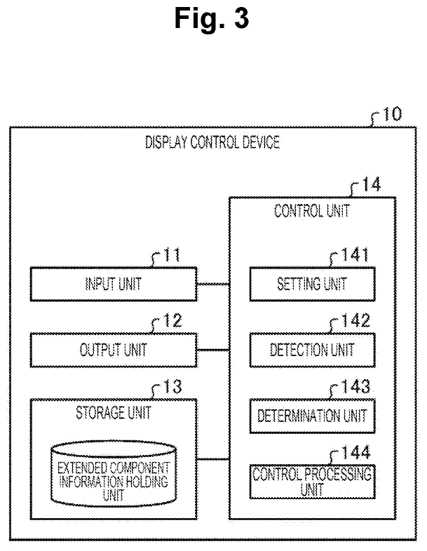

A configuration example of the display control device 10 will be described with reference to FIG. 3. The display control device 10 includes an input unit 11, an output unit 12, a storage unit 13, and a control unit 14.

The input unit 11 inputs various items of information to the display control device 10. The input unit 11 is, for example, an input interface connected to an input device such as a mouse or a keyboard. The output unit 12 outputs various items of information from the display control device 10. The output unit 12 is, for example, an output interface for outputting a screen of a web system, an existing UI on the screen, an extended UI, and the like to a display device such as a display.

The storage unit 13 stores various items of information referred to when the control unit 14 operates, and stores various items of information acquired when the control unit 14 operates. Here, the storage unit 13 is, for example, a semiconductor memory element such as a random access memory (RAM) or a flash memory, a storage device such as a hard disk or an optical disc, or the like.

The storage unit 13 includes, for example, an extended component information holding unit that holds extended component information. The extended component information is stored as, for example, extended component information indicating information on an extended UI corresponding to the UI for each UI (input item) constituting a screen of a web system.

The extended component information includes, for example, a display position of an extended UI corresponding to the input item for each input item on the screen of the web system, display information of the extended UI, and extended UI rule information indicating a rule (for example, a selection input from a pull-down indicating an input candidate, a text input, an input of a numerical value, and the like) applied to the extended UI.

Note that the extended UI rule information sets, as a rule for controlling an input operation to an extended UI of a web system, for example, a condition of an operation order, an operation time, and the number of operations of the extended UI for permitting an input operation to the extended UI. Note that the condition for permitting an input operation to the extended UI may be a condition of any one of the operation order, the operation time, and the number of operations or may be a condition of a combination thereof.

The extended UI rule information may include, in addition to the condition for permitting an input operation to the extended UI, a rule such as details of restriction of an input operation to the extended UI in a case where an input operation to the extended UI is not permitted (=a case where the condition is not satisfied), display details to the extended UI, or the like. For example, the extended UI rule information may include a rule that, in a case where an input operation to the extended UI is not permitted, an input operation to not only the corresponding extended UI but also an extended UI subsequent to the corresponding extended UI is not permitted, an alarm is displayed on the extended UI, or the like.

Note that details of the extended component information including the extended UI rule information described above can be changed by an instruction input by an administrator or the like of the display control device 10.

The control unit 14 controls the entire display control device 10. The control unit 14 includes a setting unit 141, a detection unit 142, a determination unit 143, and a control processing unit 144.

The setting unit 141 newly creates extended component information, updates and edits the extended component information, and the like on the basis of an instruction input by the administrator of the display control device 10. For example, the setting unit 141 sets a rule related to an extended UI of personal information in the extended UI rule information of the extended component information on the basis of an instruction input by the administrator of the display control device 10.

As an example, the setting unit 141 sets, regarding an extended UI of personal information, a condition of the operation order, the operation time, or the number of operations for permitting the input operation to the extended UI in the extended UI rule information on the basis of an instruction of the administrator. In addition, the setting unit 141 may set, regarding the extended UI of the personal information, a rule such as restriction details of an input operation to the extended UI or display details to the extended UI in the extended UI rule information on the basis of an instruction of the administrator in a case where the above-described condition is not satisfied.

The detection unit 142 detects an operation on an extended UI on the Web system and creates operation information indicating details of the detected operation. Then, the detection unit 142 stores the created operation information in the storage unit 13.

The determination unit 143 determines whether or not an operation on an extended UI of the web system satisfies a condition for permitting an input operation to the extended UI set in the extended UI rule information on the basis of the operation information of the extended UI.

For example, in a case where an input operation to the extended UI of the personal information set in the extended UI rule information is detected, the determination unit 143 determines whether or not the input operation to the extended UI satisfies the condition (the condition of the operation order, the operation time, or the number of operations) for permitting an input operation to the extended UI set in the extended UI rule information on the basis of the operation information of the extended UI.

The control processing unit 144 controls the input operation and the display details of each extended UI on the basis of operation information of each extended UI and a determination result by the determination unit 143.

For example, in a case where the determination unit 143 determines that the input operation to the extended UI satisfies the condition for permitting an input operation to the extended UI, the control processing unit 144 permits an input operation to an extended UI subsequent to the extended UI on the basis of the extended UI rule information. On the other hand, in a case where the determination unit 143 determines that the input operation to the extended UI does not satisfy the condition for permitting an input operation to the extended UI, the control processing unit 144 restricts an input operation to an extended UI subsequent to the extended UI on the basis of the extended UI rule information and displays an alert indicating that there is a suspicion of spoofing to the extended UI.

### Example of Processing Procedure

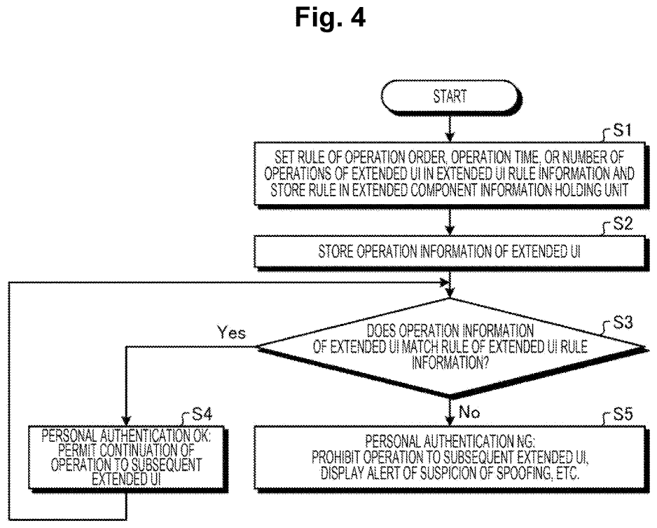

Next, an example of a processing procedure of the display control device 10 will be described with reference to FIG. 4. For example, the setting unit 141 of the display control device 10 sets information of the operation order, the operation time, or the number of operations of the extended UI of the personal information in the extended UI rule information on the basis of an instruction input from the user and stores the information in the extended component information holding unit (S1). In addition, the operation information of the extended UI detected by the detection unit 142 is stored in the storage unit 13 (S2).

Thereafter, the determination unit 143 compares the operation information of the extended UI with the rule of the extended UI rule information and determines whether or not the operation information of the extended UI matches the rule (S3). For example, the determination unit 143 determines whether or not the operation details indicated in the operation information of the extended UI of the personal information satisfy the condition of the operation order, the operation time, or the number of operations of the extended UI for permitting the input operation to the extended UI set in the extended UI rule information.

In S3, the determination unit 143 determines whether or not the operation information of the extended UI matches the rule of the extended UI rule information (S3). For example, the determination unit 143 determines whether or not the operation information of the extended UI satisfies the condition of the operation order, the operation time, or the number of operations of the extended UI for permitting the input operation to the extended UI.

Here, in a case where the determination unit 143 determines that the operation information of the extended UI matches the rule of the extended UI rule information (Yes in S3), the determination unit determines that the personal authentication is OK, and the control processing unit 144 permits continuation of the operation after the extended UI on the basis of the extended UI rule information (S4). Thereafter, the processing returns to S3.

On the other hand, when the determination unit 143 determines that the operation information of the extended UI does not match the rule of the extended UI rule information in S3 (No in S3), the determination unit 143 determines that the personal authentication is NG, and the control processing unit 144 prohibits an operation to an extended UI subsequent to the extended UI or performs a display or the like of an alert of a suspicion of spoofing on the basis of the extended UI rule information (S5).

In this way, the display control device 10 can prevent an input by spoofing. As a result, security of the Web system can be improved.

### System Configuration and Others

In addition, constituents of units illustrated in the drawings are functionally conceptual and does not necessarily have to be physically configured as illustrated in the drawings. That is, a specific form of distribution and integration of each device is not limited to the illustrated form, and all or a part thereof can be functionally or physically distributed or integrated in any unit according to various loads, usage conditions, and the like. Further, all or some of the processing functions performed in each device can be implemented by a CPU and a program executed by the CPU, or can be implemented as hardware by wired logic.

Of the processes described in the above-described embodiment, all or some of the processes described as being automatically performed may be manually performed. All or some of the processes described as being manually performed may be automatically performed by a known method.

Processing procedures, control procedures, specific names, and information including various types of data and parameters described in the above literature and drawings can be arbitrarily changed unless otherwise mentioned.

### Program

The display control device 10 can be implemented by installing a program as package software or online software in a desired computer. For example, by causing an information processing device to execute the program, the information processing device can be caused to function as the display control device 10. The information processing device mentioned here includes a desktop or a laptop personal computer. In addition, the information processing device also includes mobile communication terminals such as a smartphone, a mobile phone, and a personal handy-phone system (PHS) and terminals such as a personal digital assistant (PDA).

In addition, the display control device 10 can also be implemented as a server device, with a terminal device used by a user as a client, which provides the client with a service related to the processing mentioned above. In this case, the server device may be implemented as a web server or may be implemented as a cloud that provides a service related to the foregoing processes by outsourcing.

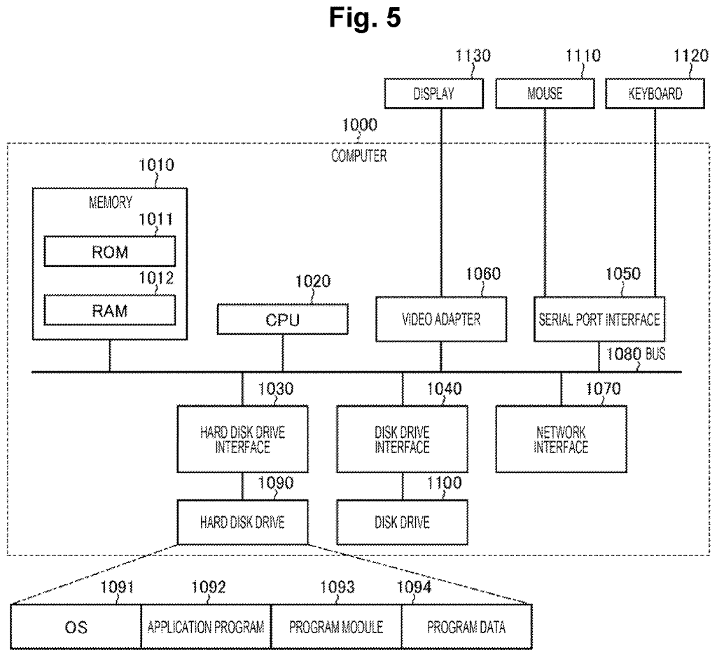

FIG. 5 is a diagram illustrating an example of a computer that executes the display control program. A computer 1000 includes, for example, a memory 1010 and a CPU 1020. The computer 1000 includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100.

The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. In other words, a program that defines each type of processing to be executed by the display control device 10 is implemented as the program module 1093 in which codes executable by the computer are described. The program module 1093 is stored in, for example, the hard disk drive 1090. For example, the program module 1093 for executing processing similar to the functional configuration of the display control device 10 is stored in the hard disk drive 1090. Note that the hard disk drive 1090 may be replaced with a solid state drive (SSD).

In addition, data used in the processing of the above-described embodiments is stored, for example, in the memory 1010 or the hard disk drive 1090 as the program data 1094. Then, the CPU 1020 reads the program module 1093 and the program data 1094 stored in the memory 1010 and the hard disk drive 1090 into the RAM 1012 as necessary and executes the program module 1093 and the program data 1094.

Note that the program module 1093 and the program data 1094 are not limited to being stored in the hard disk drive 1090 and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.
10 Display control device
11 Input unit
12 Output unit
13 Storage unit
14 Control unit
141 Setting unit
142 Detection unit
143 Determination unit
144 Control processing unit

1. A display control device comprising a processor configured to execute operations comprising:
storing extended user interface (UI) rule information, the extended UI comprises a condition specifying at least one of an operation sequence, an operation time lapse, or a number of operations of the extended UI, wherein the extended UI permits an input operation to the extended UI, and the condition is set as a rule for controlling an input operation to the extended UI of a web system;
determining whether an input operation to a predetermined extended UI satisfies the condition for permitting an input operation to the corresponding extended UI in the extended UI rule information, in response to detecting the input operation to the corresponding extended UI; and
when determining that the input operation to the extended UI does not satisfy a condition for permitting an input operation to the corresponding extended UI: restricting, an input operation to an extended UI subsequent to the corresponding extended UI.

2. The display control device according to claim 1, the processor further configured to execute operations comprising:
setting, in the extended UI rule information, a condition of the operation sequence of the corresponding extended UI, wherein the condition permits the input operation to the extended UI based on an instruction input by a user.

3. The display control device according to claim 1, the processor further configured to execute operations comprising:
setting, in the extended UI rule information, a condition of the operation time lapse of the corresponding extended UI, wherein the condition permits the input operation to the extended UI based on an instruction input by a user.

4. The display control device according to claim 1, the processor further configured to execute operations comprising:
setting, in the extended UI rule information, a condition of the number of operations of the corresponding extended UI, wherein the condition permits the input operation to the extended UI based on an instruction input by a user.

5. The display control device according to claim 1, the processor further configured to execute operations comprising:
when the input operation satisfies a predetermined condition, setting, in the extended UI rule information, restriction details of the input operation to an extended UI subsequent to the corresponding extended UI based on an instruction input by a user, wherein
when the input operation does not satisfy the predetermined condition, restricting a subsequent input operation to an extended UI after the corresponding extended UI based on the extended UI rule information.

6. The display control device according to claim 5, wherein,
when the condition of permitting an input operation to the extended UI is not satisfied, the setting further comprises setting display details to the corresponding extended UI in the extended UI rule information based on the instruction input by the user, and
when the input operation to the corresponding extended UI does not satisfy the condition of permitting an input operation of the corresponding extended UI, the restricting further comprises displaying a display detail associated with the condition not satisfied.

7. A method for controlling display as executed by a display control device, comprising:
when an input operation to a predetermined extended user interface (UI) is detected, determining whether or not the input operation to the corresponding extended UI satisfies a condition of permitting an input operation to the corresponding extended UI as specified in extended UI rule information, wherein the extended UI rule information comprises a rule for controlling the input operation to the extended UI of a web system, and the condition comprises at least one of:
an operation sequence, an operation time, or a number of operations of the extended UI for permitting the input operation to the extended UI; and and
restricting, in a case of determining that the input operation to the corresponding extended UI does not satisfy a condition for permitting an input operation to the corresponding extended UI, an input operation to an extended UI subsequent to the corresponding extended UI.

8. A computer-readable non-transitory recording medium storing a computer-executable program instructions that when executed by a processor cause a computer to execute:
when an input operation to a predetermined extended user interface (UI) is detected, determining whether or not the input operation to the corresponding extended UI satisfies a condition of permitting an input operation to the corresponding extended UI as specified in extended UI rule information, wherein the extended UI rule information comprises a rule for controlling the input operation to the extended UI of a web system, and the condition comprises at least one of: an operation sequence, an operation time, or a number of operations of the extended UI for permitting the input operation to the extended UI; and
restricting, in a case of determining that the input operation to the corresponding extended UI does not satisfy the condition for permitting an input operation to the corresponding extended UI, an input operation to an extended UI subsequent to the corresponding extended UI.

9. The display control device according to claim 1, wherein the restricting further comprises suppressing the input operation to an extended UI subsequent to the corresponding extended UI.
